(19) United States
(12) Patent Application Publication
(10) Pub. No.: US 2013/0096896 A1
(43) Pub. Date: Apr. 18, 2013

(54) 4D SATURATION MODELING

(71) Applicant: Saudi Arabian Oil Company, Dhahran (SA)

(72) Inventor: Ali M. Al-Shahri, Doha (SA)

(73) Assignee: Saudi Arabian Oil Company, Dhahran (SA)

(21) Appl. No.: 13/654,626

(22) Filed: Oct. 18, 2012

Related U.S. Application Data
(60) Provisional application No. 61/548,493, filed on Oct. 18, 2011.

(51) Int. Cl. G06G 7/57

(52) U.S. Cl. 703/10

(57) ABSTRACT

Saturation models of subsurface reservoirs of interest are formed in a computer based on data from well logs, production data and core data. Data of these types obtained over a period of time are used to form 4-D Saturation models of a reservoir illustrative of fluid movement in the reservoir over time. The saturation models based on actual data are theft available for analysts to evaluate and display how gas and water have moved within the reservoir over time.

### CROSS REFERENCE TO RELATED APPLICATION

This application claims priority and is related to U.S. Provisional Patent Application No. 61/548,493 filed Oct. 18, 2011 titled, “4D Saturation Modeling” which is incorporated by reference in its entity.

The present invention, relates to fluid saturation, modeling of subsurface reservoirs, as does commonly owned U.S. Provisional Patent Application “Reservoir Modeling With 4D Saturation Models and Simulation Models” (Attorney Docket No. 004159.007067) filed of oven date herewith, of which applicant is inventor.

### BACKGROUND OF THE INVENTION

1. Field of the Invention

The present invention relates to computerized modeling of subsurface reservoirs, and in particular to forming models of saturation based on measurements made in or about the reservoir during its production life.

2. Description of the Related Art

In the oil and gas industries, the development of underground hydrocarbon reservoirs typically includes development and analysis of computer models of the reservoir. These underground hydrocarbon reservoirs are typically complex rock formations which contain both a petroleum fluid mixture and water. The reservoir fluid content usually exists in two or more fluid phases. The petroleum mixture in reservoir fluids is produced by wells drilled into and completed in these rock formations.

A geologically realistic model of the reservoir, and the presence of its fluids, helps in forecasting the optimal future oil mid gas recovery from hydrocarbon reservoirs. Oil and gas companies have come to depend on geological models as an important tool to enhance the ability to exploit a petroleum reserve. Geological models of reservoirs and oil/gas fields have become increasingly large and complex. In such models, the reservoir is organized into a number of individual cells. Seismic data with increasing accuracy has permitted the cells to be on the order of 25 meters areal (x and y axis) intervals. For what are known as giant reservoirs, the number of cells is the least hundreds of millions, and reservoirs of what is known, as giga-cell size (a billion cells or more) are encountered.

The presence and movement of fluids in the reservoir varies over the reservoir, and certain characteristics or measures as water or oil saturation and fluid encroachment made during production from existing wells in a reservoir, are valuable in the planning and development of the reservoir.

When characterizing and developing a reservoir field, a model of the reservoir covering the entire reservoir has been required to be built to provide an accurate model for reservoir planning. Accurate indications of the presence and movement of reservoir are an essential input in fluids in reservoir evaluation and planning. So far as is known, modeling of the presence and movement of reservoir fluids over a projected reservoir life has been based on reservoir simulation models. An example of such a simulation model is that of U.S. Pat. No. 7,526,418, which is owned by the assignee of the present invention.

Briefly, the present invention provides a new and improved computer implemented method of obtaining measures in a computer system of fluid saturation of a subsurface reservoir over a period of time during production from the reservoir based on data measurements from wells in the reservoir. According to the method of the present invention initial data about formations in the reservoir received from wells in the reservoir are processed to determine an initial measure of fluid saturation of formations in the reservoir at an initial time. The determined initial measure of fluid saturation in formations of interest in the reservoir is transferred to a data memory of the computer system. Production logs and data during production, subsequent to the initial time from wells in the reservoir are processed to determine measures of fluid saturation of formations during production. The determined measures of fluid saturation of formations for the reservoir are assembled, and an output display formed of selected ones of the determined measures of fluid saturation in formations of interest in the reservoir for evaluation of formation fluid saturation changes during production from the reservoir.

The present invention provides a new and improved, data, processing system for obtaining measures of fluid saturation of a subsurface reservoir over a period of time during production from the reservoir based on data measurements from wells in the reservoir. The data processing system includes a processor which processes initial data about formations in the reservoir received from, wells in the reservoir to determine an initial measure of fluid saturation of formations in the reservoir at an initial time. The processor also transfers the determined initial measure of fluid saturation in formations of interest in the reservoir to a data memory of the computer system. The processor of the data processing system, also processes production data during production subsequent to the initial time from wells in the reservoir to determine measures of fluid saturation of formations during production, and assembles in memory the determined measures of fluid saturation of formations for the reservoir. The data processing system also includes an output display which forms, images of selected ones of the determined measures of fluid saturation in formations of interest in the reservoir for evaluation of formation fluid saturation changes during production from the reservoir.

The present invention also provides a new and improved data storage device which has stored in a computer readable medium computer operable instructions for causing a data processing system to obtain measures in a computer system of fluid saturation of a subsurface reservoir over a period of time during production from the reservoir based on data measurements from wells in the reservoir. The instructions stored in the data storage device causing the data processing system to process initial data about formations in the reservoir received from wells in the reservoir to determine an initial measure of fluid saturation of formations in the reservoir at an initial time. The instructions also cause the data processing system to transfer the determined initial measure of fluid saturation in formations of interest in the reservoir to a data memory of the data processing system. The instructions cause the data processing system to process production data during production subsequent to the initial time from wells in the reservoir and determine measures of fluid saturation of formations during production. The instructions also cause the data processing system to assembling in memory the determined measures of fluid saturation of formations for the reservoir, and to form an output display of selected ones of the determined measures of fluid saturation in formations of interest in the reservoir for evaluation of formation fluid saturation changes during production from the reservoir.

### BRIEF DESCRIPTION OF TEE DRAWINGS

FIG. 1 is a functional block diagram of an initial set of data processing steps performed in a data processing system for saturation modeling of subsurface earth formations according to the present invention.

FIG. 2 is a functional block diagram of a subsequent set of data processing steps performed in a data processing system for fluid encroachment modeling during saturation modeling of subsurface earth formations according to the present invention.

FIG. 3 is a schematic block diagram of a data processing system for saturation modeling of subsurface earth formations according to the present invention.

FIG. 4 is a display of a 4D saturation model according to the present invention for a region of interest in a subsurface reservoir at a particular time during it production life.

FIG. 4A is an image of a computer display showing processing results during saturation modeling according to the present invention.

FIG. 4B is a plot of fluid production measures as a function of production life according to the present invention of the formation shown in FIG. 4.

FIG. 4C is a well log from a well bore in the formation shown in FIG. 4 at one time of interest during its production life.

FIG. 4D is a well log from the well bore shown in FIG. 4C at a different time of interest during its production life.

FIG. 4E is plot of input data logs from the formation shown in the display of FIG. 4A.

FIG. 4F is a plot of core data for a group of wells in the formation shown in in the display of FIG. 4A.

FIG. 5 is a display of a saturation model according to the present invention for a region of interest in a subsurface reservoir at a particular time in this production life.

FIG. 5A is vertical cross-sectional view of the saturation model of FIG. 5 taken along the line 5A-5A of FIG. 5.

FIG. 5B is vertical cross-sectional view of the saturation model of FIG. 5 taken along the line 5B-5B of FIG. 5.

FIG. 6 is a display of a saturation model according to the present invention for a region of interest showing vertical sweep.

FIG. 7 is a display of a saturation model according to the present invention for a region of interest showing areal sweep.

FIGS. 7A, 7B, 7C and 7D are enlarged views of indicated portions of the display of FIG. 7.

FIG. 8 is a display of a saturation model according to the present invention for a region of interest in a subsurface reservoir at a particular time in this production life.

### DETAILED DESCRIPTION OF THE PREFERRED EMBODIMENTS

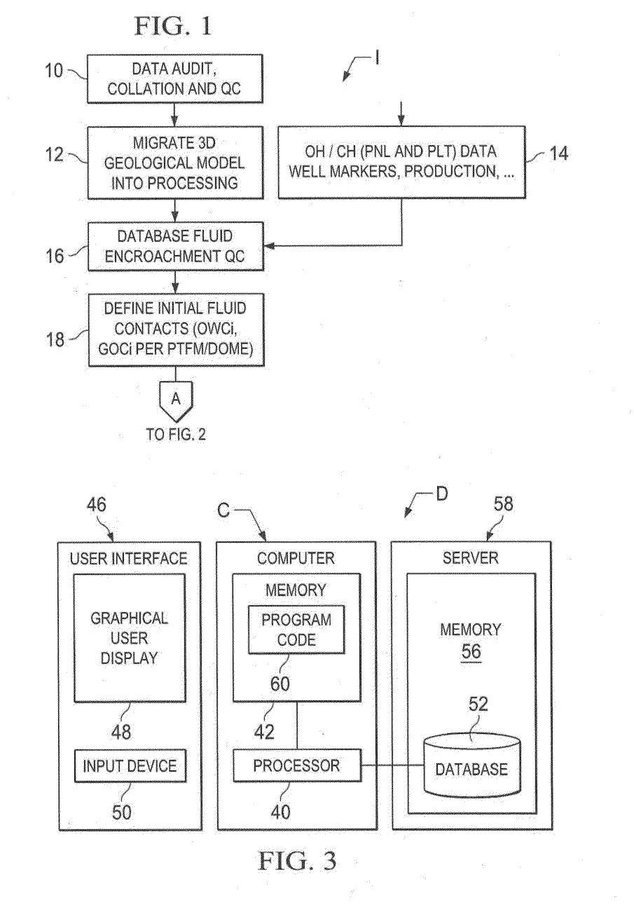

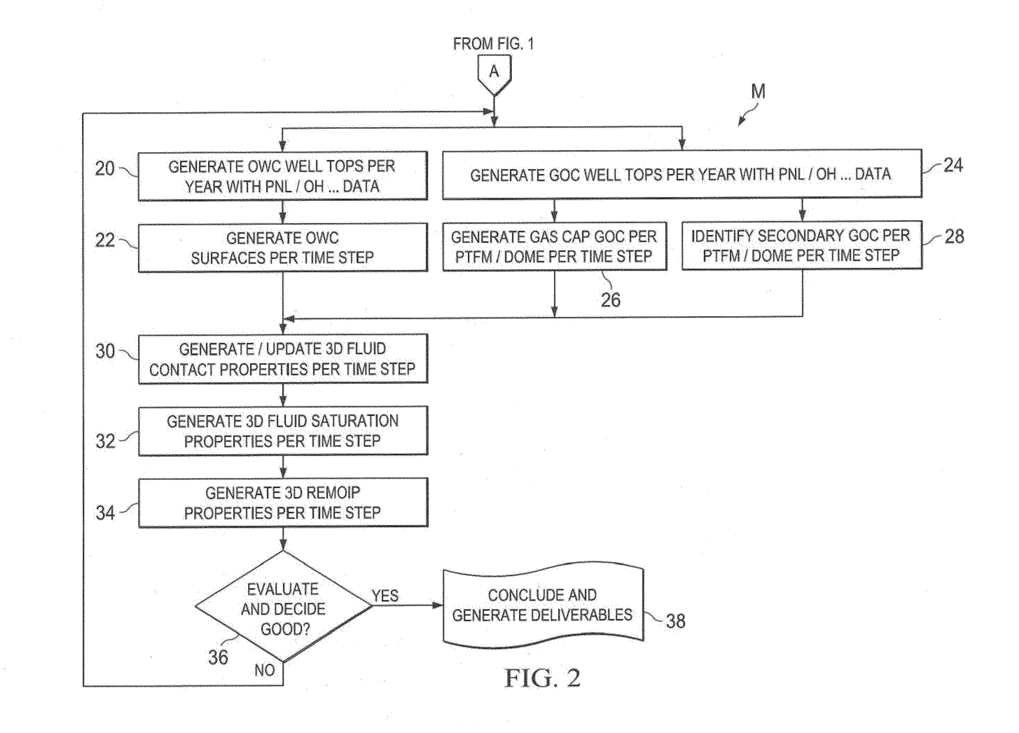

In the drawings, a flowchart shown in FIGS. 1 and 2 indicates the basic computer processing sequence of the present invention for forming models of saturation based on measurements made in or about the reservoir during its production life according to the present invention. The models of saturation formed include fluid saturation, fluid encroachment, initial fluid contact, oil water contact, gas oil contact and other saturation measures, as will, be described.

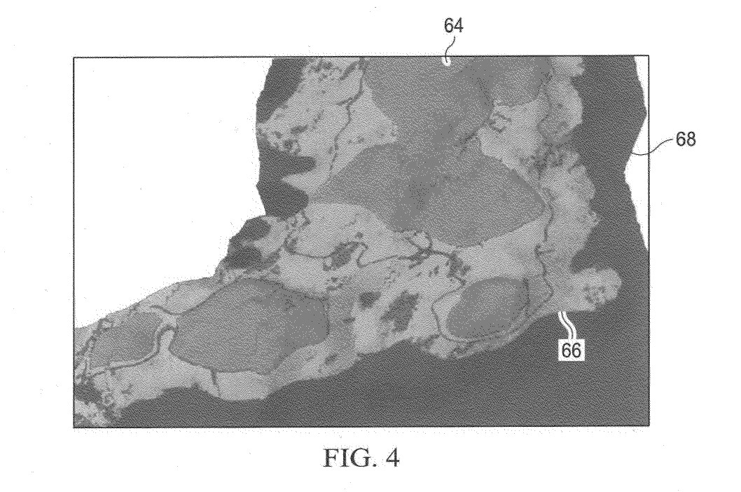

The processing sequence includes a flow chart I (FIG. 1) illustrating the processing sequence of the present invention relating to formation of a database and initial reservoir saturation model based on data obtained from wells in the reservoir and other data sources. The processing sequence of the present invention also includes a flow chart M (FIG. 2) illustrating the sequence for processing data resulting from the procedures of the flow chart I and data obtained during production from the reservoir for purposes of fluid encroachment modeling, as will be described in detail below. The processing of data according to FIGS. 1 and 2 to obtain measures of fluid saturation of a subsurface reservoir over a period of time during production from the reservoir based on data measurements from wells in the reservoir is performed in a data processing system D (FIG. 3) as will also be described.

Turning to FIG. 1, processing in data processing system D begins during step 10 (FIG. 1) by auditing or collection, collation or arrangement and quality control of input parameters or data for processing according to the present invention. The input parameters or data include the following: an initial set of 3D geological model data for the reservoir of interest; individual cell dimensions and locations in the x, y and z directions for the reservoir; existing well locations and directions through the reservoir; petrophysical measurements and known values of attributes from core sample data; and data available from well logs where log data have been obtained. During step 10, the input parameters and data are thus evaluated and formatted for processing during subsequent steps. If errors or irregularities are detected in certain data during quality control in processing during step 10, such data may be omitted from processing or may be subject to analysis for corrective action to be taken.

During step 12 of processing in the data processing system D, the stored initial 3D geological model data is migrated from database memory for processing fey petrophysical modeling. In one embodiment of the present invention, such, petrophysical modeling may fee performed for instance by a processing system known as PETREL available from Schlumberger Corporation. It should also be understood that the petrophysical modeling may, if desired, be performed according to other available techniques such as those available as: GOCAD from GoCAD Consortium; Vulcan from Vulcan Software; DataMine from DataMine Ltd; FraeSys from Colder Associates, Inc.; GeoBlock from Source Forge; or deepExploration from Right Hemisphere, Inc.; or other suitable source.

During step 14, input saturation data obtained from processing data from well logs including open hole (OH) logs from the wells hi the reservoir before production, as well as data cased hole (CH) logs such as pulsed neutron (PNL) or production logging tool (PLT) logs after casing has been installed in wells are populated or made available to be located into the geological model being processed. In addition during step 14, data regarding well production, completion, well markers, well head data, well directional survey are populated, or made available to be located into the geological model being processed.

During step 16, a quality control analysis or correlation is made between the geological model data migrated for processing during step 12 and the open hole log data from step 14. If errors or irregularities are detected between geological model data and open hole log data during quality control in processing during step 16, such data may be omitted from processing or may be subject to analysis for corrective action to be taken. Also during step 16, a quality control analysis or correlation is made between the fluid saturation measures available form production log data, open hole log data and also the initial saturation model.

During step 18, initial, fluid contacts (for both Free Water Level and Gas-Oil) are determined for each of the various regions, platforms, domes and fields of interest in the reservoir. The processing during step 18 is done by a petrophysical model system, of the type described above in connection with step 12. As a result of step 18, a fluid encroachment database and an initial fluid encroachment for the reservoir is formed and available in the data processing system D for further fluid encroachment modeling according to the step in the flow chart, as will be described.

Fluid encroachment modeling and reservoir analysis (FIG. 2) according to the present invention begins with step 20. Again, the processing during step 20 is done by a petrophysical model system of the type described above for step 12. During step 20 oil-water contact (OWC) well tops, or the depth of the geological layer wherein such contact occurs, are determined, from either or both of PNL logs and OH logs. Further, any OWC information reported on well events in the input data is taken into account in the input data. Also, during step 20, indications of oil-water contact (OWC) are generated for each year during previous and projected production life of the reservoir for the well tops in the geological model so that all locations of such contact in the reservoir model are identified. During step 20, OWC in the years where OWC from logs is not available are determined by interpolation using measures of production of the well or platform in question for those years.

Next, during step 22 a measure of the location of OWC surface for each year or time steps over the time of interest for the reservoir is established. During step 22, quality control of OWC surfaces previously generated is performed: Synthetic OWC logs×Water Production.

During step 24 gas-oil contact (GOC) wed tops, or the depth of the geological layer wherein such contact occurs, are determined from either or both of PNL logs and OH logs. Further, any GOC information reported on well events in the input data is taken into account in the input data.

During step 26, indications of gas-oil contact (GOC) are generated for each year during previous and projected production life of the reservoir for the well tops in the geological model so that all locations of such contact in the reservoir model are identified. During step 26, GOC in the years where GOC from logs is not available are also determined by interpolation using measures of production of the well or platform in question for those years.

During step 28, indications of secondary GOC are identified and the 3D fluid contact properties determined during step 24 are updated with identified secondary GOC 3D fluid contact for the platforms, regions and domes of interest in the reservoir. Adjustments are also made during step 28 for changes in GOC levels is wells affected by gas conning and the 3D fluid contact model updated accordingly.

During step 30, a 3D fluid contact property is generated for each year or time step over the time of interest for the reservoir. During step 30, a quality control analysis or correlation is made between the 3D fluid contact properties for the various time steps generated based on the data from the various logs available from weds in the reservoir: production/completion, OH and PNL. If errors or irregularities are detected in the 3D fluid contact properties, such data may be subject to analysis for corrective action, to be taken.

During step 32, a measure of 3D saturation properties is determined for the various time steps of interest, and thus a 4D saturation property for foe reservoir of interest is obtained. The 4D saturation property obtained is obtained from actual data measurements obtained for wells in the reservoir before and during production and is thus not based on simulation. Thus, there is no need to confirm that the simulation data is representative of reservoir conditions. Reservoir saturation over the production life can be determined from production data. Actual fluid movement over time can be determined and observed.

From the 4D simulation property obtained during step 32, a 3D measure of remaining oil in place (REMOIP) properties per time step (and thus a 4D REMOIP property) is formed during step 34. Also during step 34, maps of remaining oil in place or REMOIP may be formed for layer or zones of interest in the reservoir being modelled according to the present invention data.

During step 36, the reservoir fluid encroachment measures resulting from saturation modelling according to the present invention are evaluated for accuracy and acceptability. During step 38, if the results of step 36 indicate acceptable results the results are updated in memory of the data processing system D. The updated results can then be displayed or otherwise made available during step 38 as deliverable output data. If further processing is indicated necessary during step 36, processing returns to steps 20 and 24, as indicated in FIG. 2.

As illustrated in FIG. 3, a data processing system D according to the present invention includes a computer C having a processor 40 and memory 42 coupled to processor 40 to store operating instructions, control information and database records therein. The computer C may, if desired, be a portable digital processor, such as a personal computer in the form of a laptop computer, notebook computer or other suitable programmed or programmable digital data processing apparatus, such as a desktop computer. It should also be understood that the computer C may be a multicore processor with nodes such as those from Intel Corporation or Advanced Micro Devices (AMD), an HPC Linux cluster computer or a mainframe computer of any conventional type of suitable processing capacity such as those available from International Business Machines (IBM) of Armonk, N.Y. or other source.

The computer C has a user interface 46 and an output data display 48 for displaying output data or records of lithological fades and reservoir attributes according to the present invention. The output display 48 includes components such as a printer and an output display screen capable of providing printed output information, or visible displays in the form of graphs, data sheets, graphical images, data plots and the like as output records or images.

The user interface 46 of computer C also includes a suitable user input device or input/output control unit 50 to provide a user access to control, or access information and database records and operate the computer C. Data processing system D further includes a database 52 stored in computer memory, which may be internal memory 42, or an external, networked, or non-networked memory as indicated at 56 in an associated database server 58.

The data processing system D includes program code 60 stored in memory 42 of the computer C. The program code 60, according to the present invention is in the form of computer operable instructions causing the data processor 40 to perform the computer implemented method of the present invention in the manner described above and illustrated in FIGS. 1 and 2.

It should be noted that program code 60 may be in the form of microcode, programs, routines, or symbolic computer operable languages that provide a specific set of ordered operations that control the functioning of the data processing system D and direct its operation. The instructions of program code 60 may be may be stored m memory 42 of the computer C, or on computer diskette, magnetic tape, conventional hard disk drive, electronic read-only memory, optical storage device, or other appropriate data storage device having a non-volatile computer usable medium stored thereon. Program code 60 may also be contained on a data storage device such as server 58 as a computer readable medium, as shown.

The method of the present invention performed in the computer C can be implemented utilizing the computer program steps of FIGS. 1 and 2 stored, in memory 42 and executable by system processor 40 of computer C. The input data to processing system D are the well log data and other data regarding the reservoir described above.

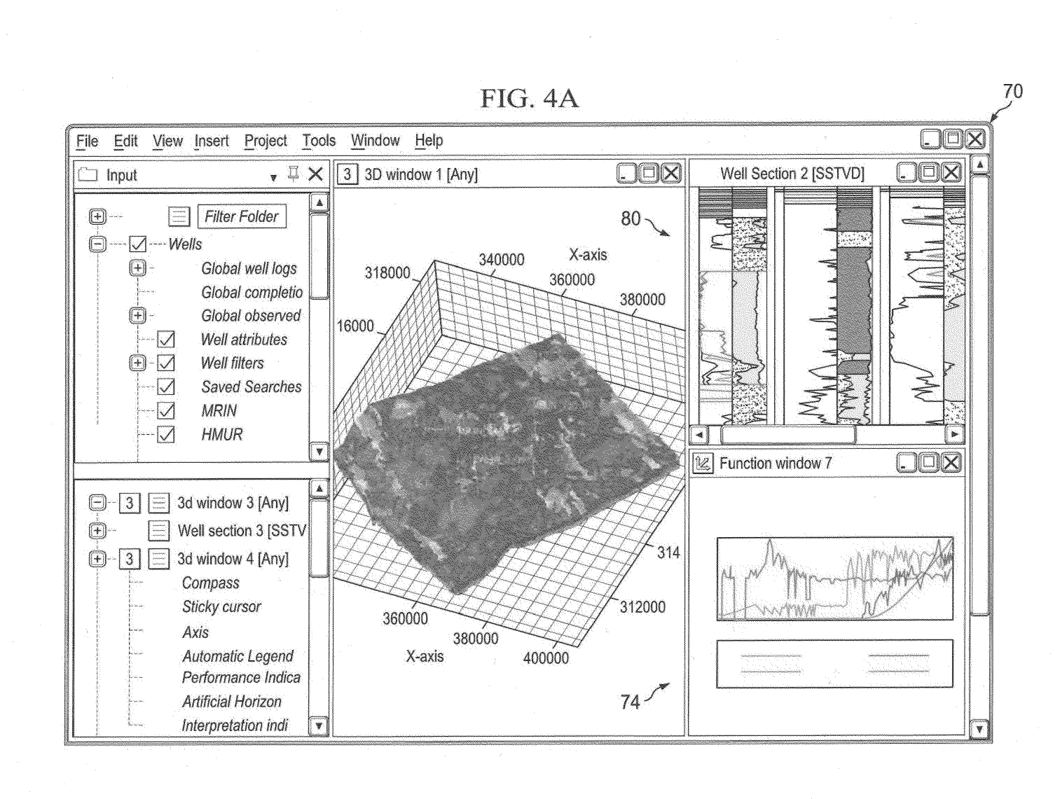

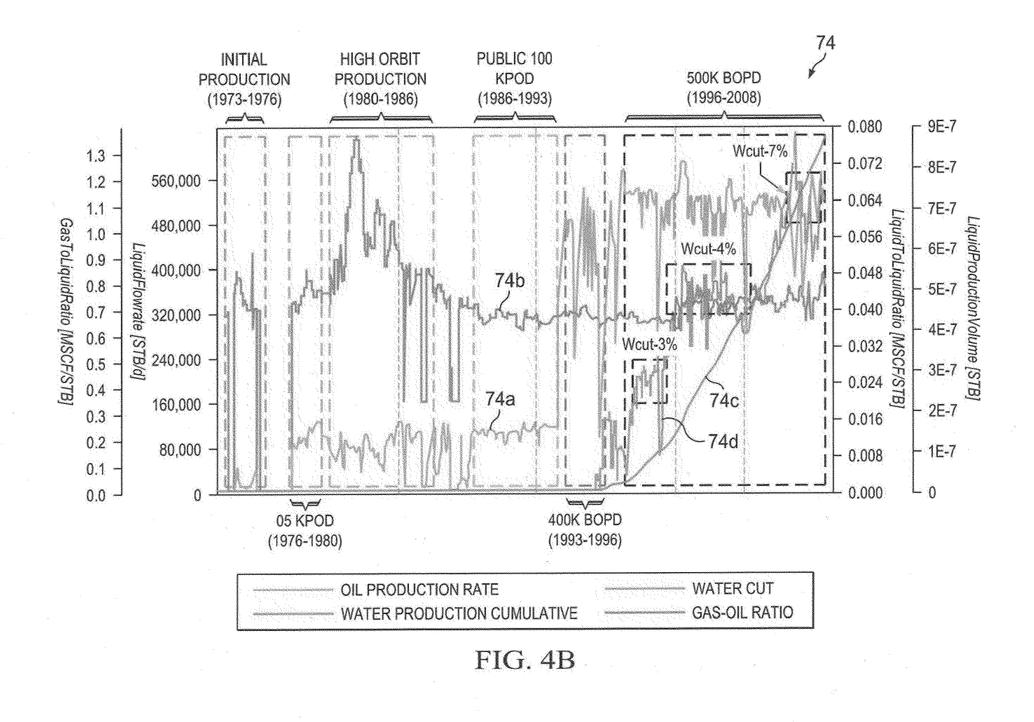

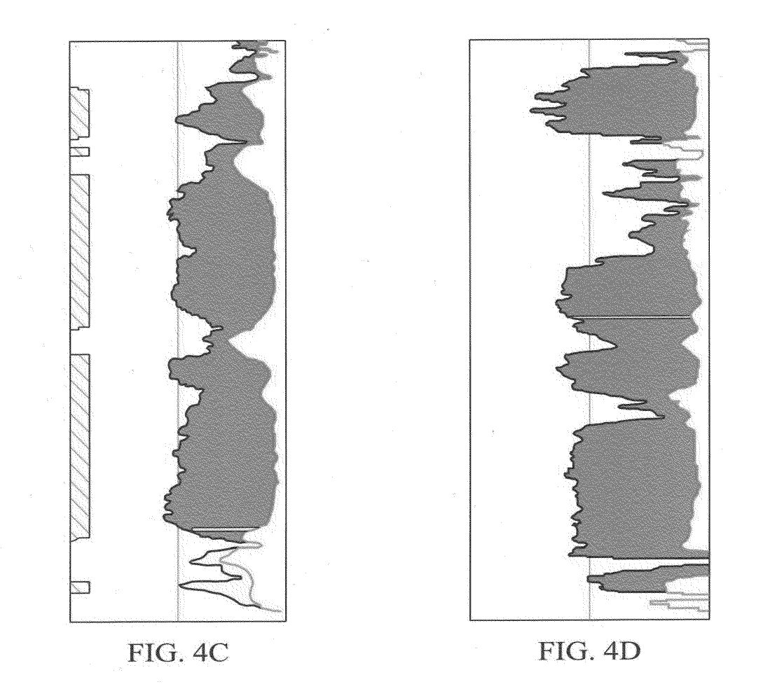

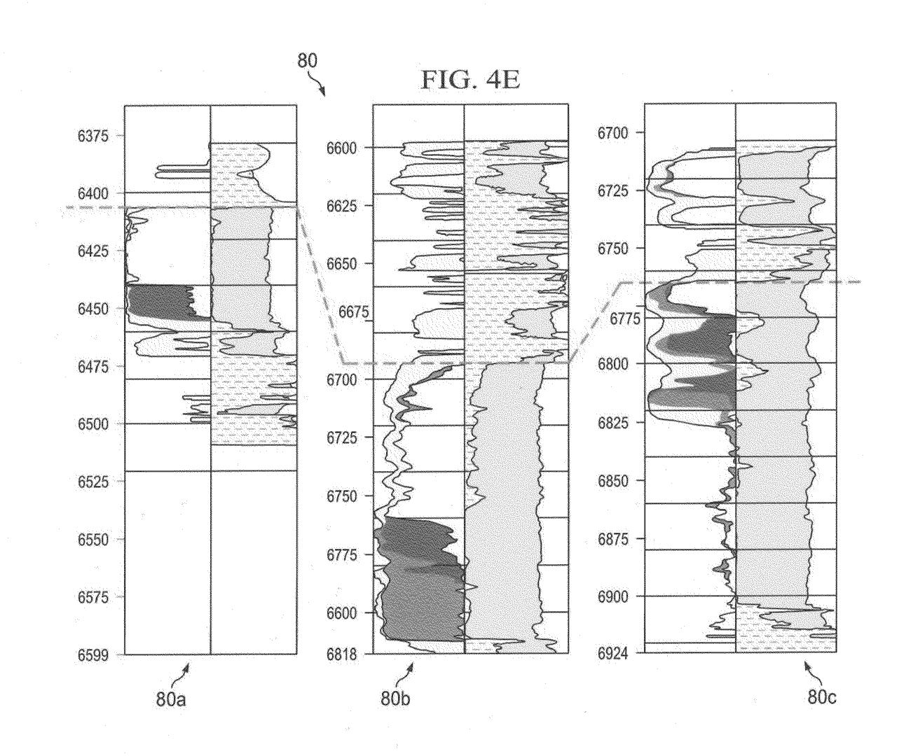

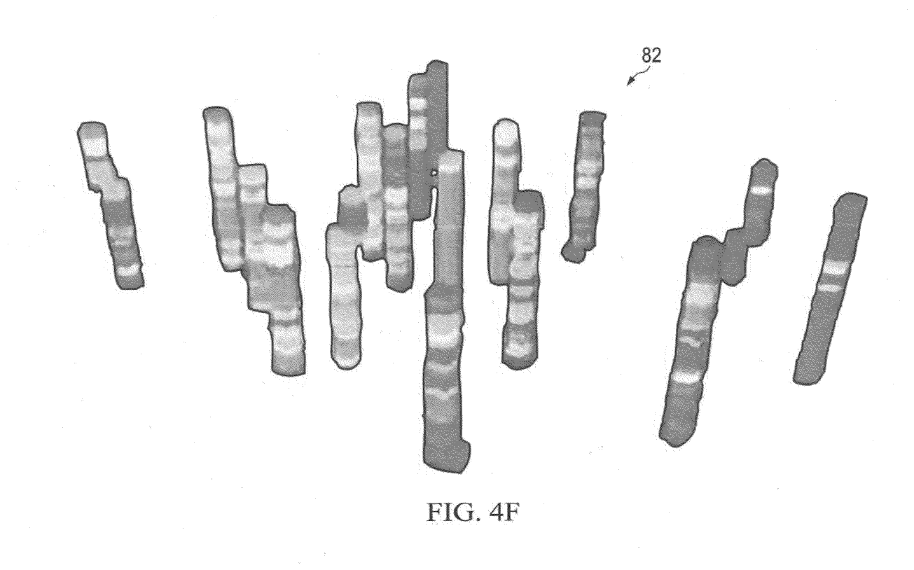

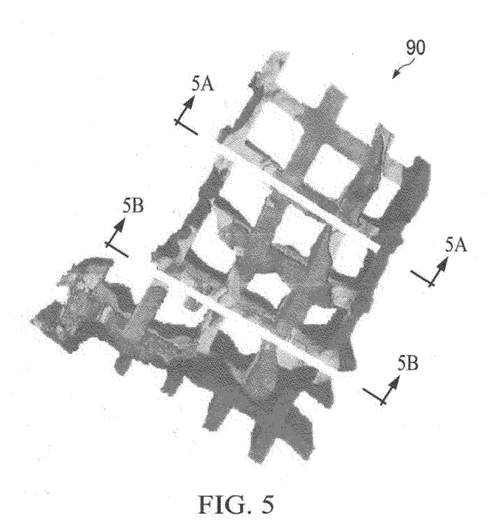

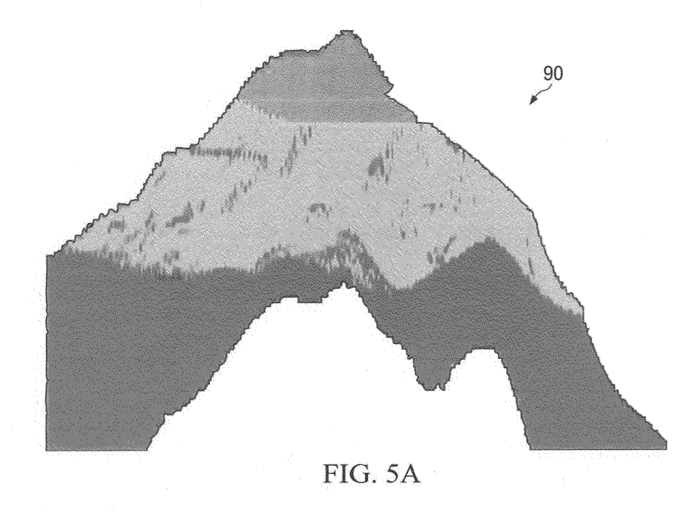

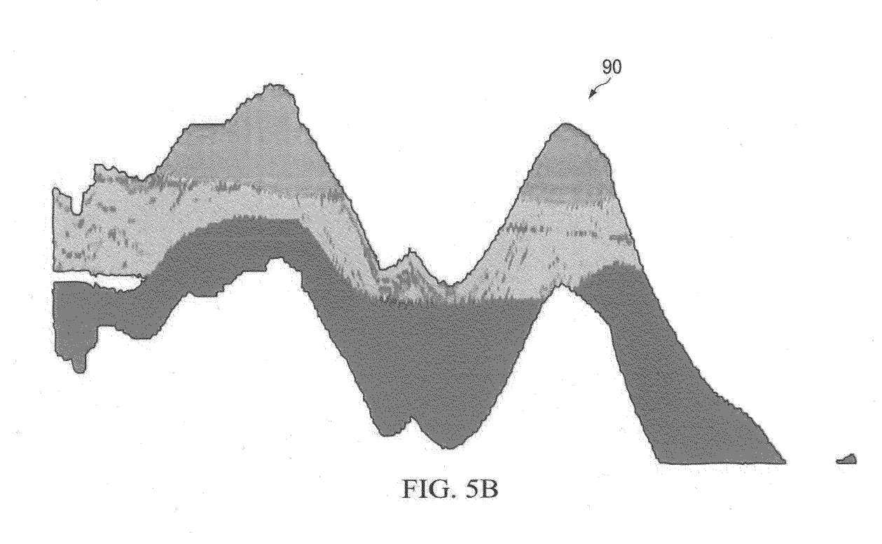

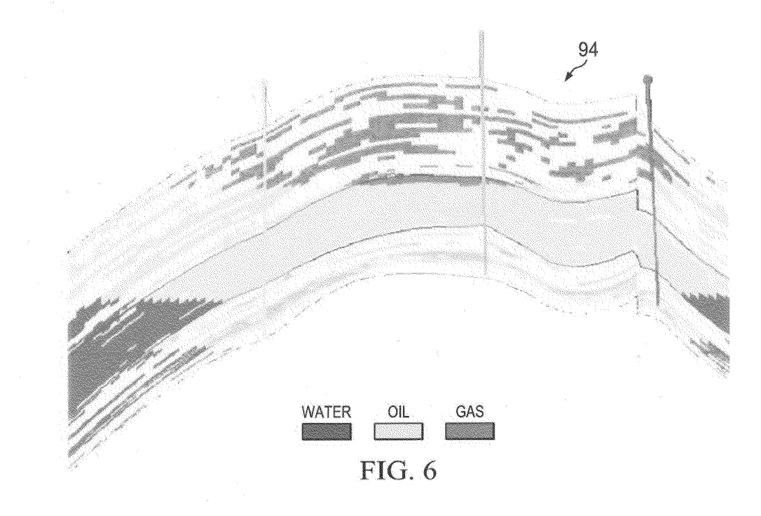

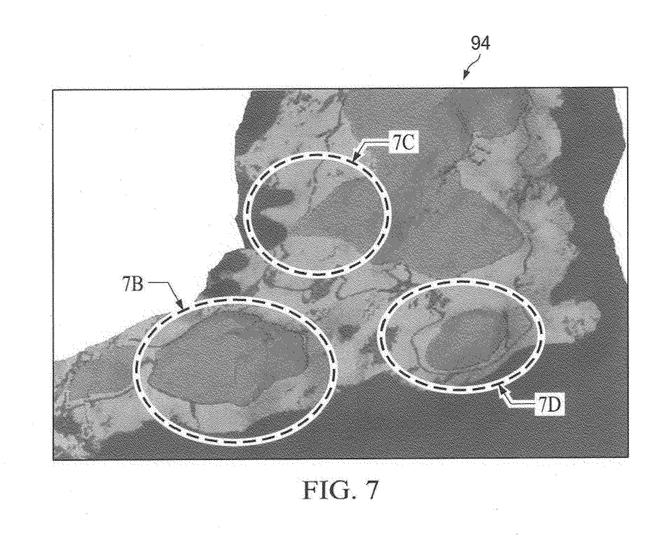

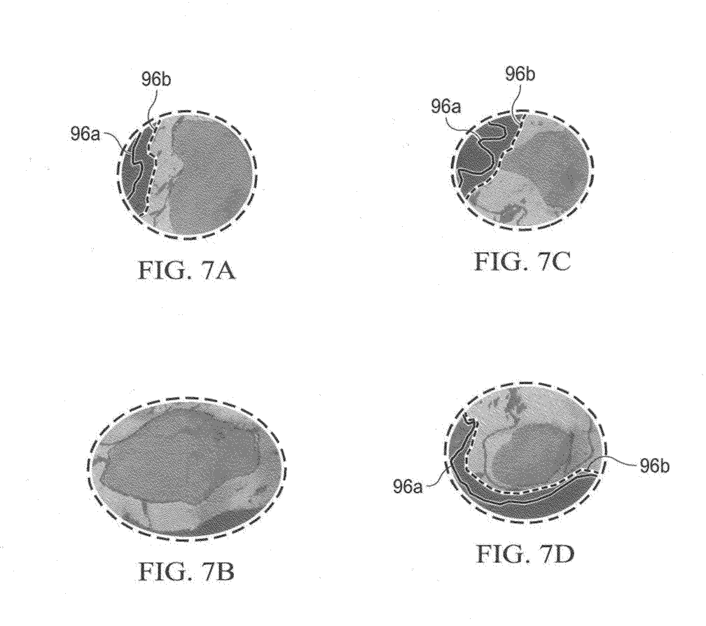

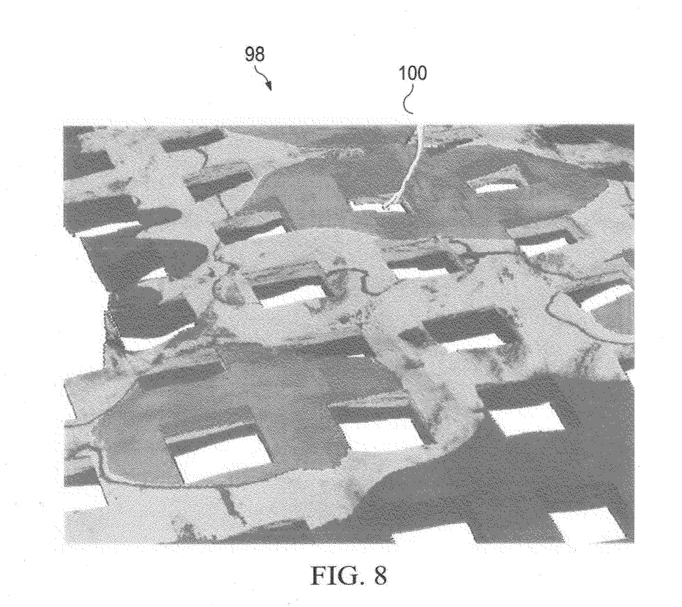

FIG. 4 is a view looking downwardly on an example formation of interest in a 4D saturation model formed of a subsurface reservoir at a particular time during its production life according to the present invention. FIG. 4 shows areal fluid (oil, water and gas) distribution at the particular time of interest. Similar plots of areal distribution are generated at other time steps during the reservoir production life. In FIG. 4, those portions 64 of the formation in red are indicative of saturation values based on processing results where gas is present in the formation, those portions 66 in green are indicative of saturation values where oils is present, and those areas 68 in blue indicate saturation, values where water is present, Models according to the present invention from which displays like those illustrated in FIG. 4 are formed for various times, usually years, during the production history or life and are used, as will be set forth, for characterizing and developing reservoirs. Examples include reservoir monitoring (FIG. 5); vertical sweep (FIG. 6) or the extent of a formation fend contact with the formation in a vertical plane through the reservoir model; horizontal sweep (FIG. 7) or the extent of a formation fluid contact with the formation in a horizontal plane through the reservoir model; and geosteering (FIG. 8), as will be described.

FIG. 4A is an image 70 of an example computer display of a reservoir model 72 made, available according to the present invention on display 48 (FIG. 3) during processing step 38 (FIG. 2). The image 70 of FIG. 4A contains a plot 74 of fluid production measures as a function of production life according to the present invention of the formation as a function of time over past production years from the reservoir. Plot 74 is shown in enlarged form in FIG. 4B, and contains plots of oil production rate as indicated at 74a, gas-oil ratio (GOR) as indicated at 74b, water cut as indicated at 74c and cumulative water production as indicated at 74d.

FIG. 4C is a plot 76 of input data from a well log as a function of depth obtained in a well bore in the formation shown in the model of FIG. 4 at one time during its production life. The data plotted in FIG. 4C serves as a data source for incorporating fluid sources into the model.

FIG. 4D is a another plot 78 of input data from a well log as a function of depth obtained in a well bore in the formation shown in FIG. 4 at a different time during its production life. The data plotted in FIG. 41) also serves as a data source for incorporating fluid sources into the model.

FIG. 4E is au enlarged view of plot 80 shown in the display 70 of FIG. 4A according to the present invention of the formation shown in the display of FIG. 4A. Plot 80 represents three log plots 80a, 80b and 80c of input data from, the formation shown in FIG. 4A.

FIG. 4F is a display 82 of au isometric view of a group of well bores at their respective locations in the reservoir model of FIG. 4A. The various well bores indicate core data values by variations in color as a function of well bore depth in the formation shown in FIG. 4A.

FIG. 5 is an image 90 of an example display of a 3D model of a reservoir of interest indicating saturation of portions of the reservoir adjacent wells in the reservoir at a particular time in its production life. FIG. 5 shows the capability to display both area and vertical fluid encroachment data at a selected time step. Saturation of the reservoir is indicated in the image 90 in a like manner to that displayed in FIG. 4. FIG. 5A is vertical cross-sectional view of the saturation model of FIG. 5 taken along the line 5A-5A of FIG. 5 indicating saturation of the formation as a function of depth. Similarly, FIG. 5B is vertical cross-sectional view of the saturation model of FIG. 5 taken along the line 5B-5B of FIG. 5 indicating saturation of the formation as a function of depth. Displays like those of FIGS. 5A and 5B at a reservoir region of interest at selected times during reservoir production can be formed to display fluid encroachment data according to the present invention and compared with each other for purposes of reservoir monitoring.

FIG. 6 is an image 94 of a display of a vertical cross-sectional view of a saturation model according to the present invention. The display in FIG. 6 shows fluid distribution in conjunction with geological modeling layering. In the display shown at 94, the presence of oil, gas and water are indicated at locations where data and measurements from the reservoir indicate their respective relative presence, by color as indicated. Displays like that at 94 in FIG. 6 at a reservoir region of interest at selected times during reservoir production can be formed according to the present invention and compared with each other for purposes of forming indications of vertical sweep at the reservoir region of interest.

FIG. 7 is an image 96 of a display of a horizontal cross-sectional view of a saturation model according to the present invention. In the display shown at 96, the presence of oil, gas and water are indicated by color in a like manner to FIG. 4 at locations where data and measurements from the reservoir indicate their respective relative presence. Displays like that at 96 in FIG. 7 at a reservoir region of interest at selected location during reservoir production and at different time can be formed according to the present invention and compared with each other for purposes of forming indications of vertical sweep at the reservoir region of interest FIGS. 7A, 7B, 7C and 7D are enlarged or close up views of portions of the display of FIG. 7 and at different times during production and indicate by the presence of solid lines 96a and dashed lines 96b the relative change in saturation with time. The location of the portions shown in FIGS. 7B through 7D are indicated by corresponding references in FIG. 7.

FIG. 8 is an image 98 of an example display of a 3D model of a reservoir of interest indicating 4D saturation of portions of the reservoir adjacent wells in the reservoir at a particular time in its production, life. Saturation of the reservoir is indicated in the image 98 in a like manner to that displayed in FIGS. 4 and 5. FIG. 8 also includes an image 100 of a well path or trajectory through the earth to and near the reservoir 98. Displays like those of FIG. 8 at a reservoir region of interest can be formed according to the present invention and compared with each other for purposes of assisting in geosteering drilling of the well path to a desired target of interest in the reservoir of interest based on information represented by the saturation model.

From the foregoing, it can be seen that the present invention provides saturation models based on actual reservoir data, such as production data and well logs over time during production from the reservoir. Thus, evaluation of fluid presence and movement over time in the reservoir is available based on actual measured data.

One of the difficult tasks in reservoir engineering is to obtain a perfect match for reservoir simulation models at different time during simulation of reservoir production. However, the present invention provides a reservoir saturation model based on actual data at a known time. The saturation model of the present invention based on actual data then can serve as a reference for verifying a simulation model for that known time, and thus serves as an independent check of the simulation model.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A computer implemented method of obtaining measures in a data processing system of fluid saturation of a subsurface reservoir over a period of time during production from the reservoir based on data measurements from wells in the reservoir, the method comprising the computer processing steps of:
(a) processing initial data about formations in the reservoir received from wells in the reservoir to determine an initial measure of fluid saturation of formations in the reservoir at an initial time;
(b) transferring the determined initial measure of fluid saturation in formations of interest in the reservoir to a data memory of the data processing system;
(c) processing production data during production subsequent to the initial time from wells in the reservoir to determine measures of fluid saturation of formations during production;
(d) assembling in the memory the determined measures of fluid saturation of formations for the reservoir; and
(e) forming an output display of selected ones of the determined measures of fluid saturation in formations of interest in the reservoir for evaluation of formation fluid saturation changes during production flora the reservoir.

2. The computer implemented method of claim 1, wherein the initial data comprises: initial evaluation log data and well core sample data.

3. The computer implemented method of claim 1, wherein the production, data comprises: production log data.

4. The computer implemented method of claim 1, wherein the step of processing initial data about formations in the reservoir includes the step of forming measures of initial fluid contact levels in formations of the reservoir.

5. The computer implemented method of claim 1, wherein the step of processing production data about formations in the reservoir includes the step of forming measures of oil-water fluid contact levels in formations of the reservoir during production.

6. The computer implemented method of claim 1, wherein the step of processing production data, about formations in the reservoir includes the step of forming measures of oil-wafer fluid contact surfaces in formations of the reservoir during production.

7. The computer implemented method of claim 1, wherein, the step of processing production data about formations in the reservoir includes the step of forming measures of gas-oil fluid contact levels in formations of the reservoir during production.

8. The computer implemented method of claim 1, wherein the step of processing the production data for a specified time to form a model of fluid saturation of formations comprises the step of forming a petrophysical model of fluid saturation at the specified time, for areas adjacent the wells from which production data are received.

9. The computer implemented method of claim 1, wherein the step of forming an output display further includes, the step of forming displays of changes between selected ones of the determined measures of fluid saturation.

10. A data processing system for obtaining measures of fluid saturation of a subsurface reservoir over a period of time during production from the reservoir based on data measurements from wells in the reservoir, the data processing system comprising:
(a) a processor performing the steps of:
(1) processing initial data about formations in the reservoir received from wells in the reservoir to determine an initial measure of fluid saturation of formations in the reservoir at an initial time;
(2) transferring the determined initial measure of fluid saturation in formations of interest in the reservoir to a data memory of the data processing system;
(3) processing production data during production subsequent to the initial time from wells in the reservoir to determine measures of fluid saturation of formations during production;
(4) assembling in memory the determined measures of fluid saturation of formations for the reservoir; and
(b) an output display forming images of selected ones of the determined measures of fluid saturation in formations of interest in the reservoir for evaluation of formation fluid saturation changes during production from the reservoir.

11. The data processing system of claim 10, wherein the initial data, comprises initial evaluation log data and well core sample data.

12. The data processing system of claim 10, wherein the production data comprises production log data.

13. The data processing system of claim 10, wherein, the processor in performing the step of processing initial data about formations in the reservoir further performs the step of forming measures of initial fluid contact levels in formations of the reservoir.

14. The data processing system of claim 10, wherein the processor in performing the step of processing production, data about formations in the reservoir further performs the step of forming measures of oil-water fluid contact levels in formations of the reservoir during production.

15. The data processing system of claim 10, wherein the processor in performing the step of processing production data about formations in the reservoir further performs the step of forming measures of oil-water fluid contact surfaces in formations of the reservoir during production.

16. The data processing system of claim 10, wherein the processor in performing the step of processing production data about formations in the reservoir further performs the step of forming measures of gas-oil fluid contact levels in formations of the reservoir during production.

17. The data processing system of claim 10, wherein the processor in performing the step of processing production data about formations in the reservoir further performs the step of processing the production data for a specified time; and the display in performing the step of forming a model of fluid saturation of formations performs the step of forming a petrophysical model of fluid saturation at the specified time for areas adjacent the wells from which production data are received.

18. The data processing system of claim 10, further including the output display forming displays of changes between selected ones of the determined measures of fluid saturation.

19. A data storage device having stored in a computer readable medium computer operable instructions for causing a date processing system to obtain measures in a computer system of fluid saturation of a subsurface reservoir over a period of time during production from the reservoir based on data measurements from wells in the reservoir, the instructions stored in the data storage device causing the data processing system to perform the following steps:
(a) processing initial data about formations in the reservoir received from wells in the reservoir to determine an initial measure of fluid saturation of formations in the reservoir at an initial time;
(b) transferring the determined initial measure of fluid saturation in formations of interest in the reservoir to a data memory of the computer system;
(c) processing production data during production subsequent to the initial time from wells in the reservoir to determine measures of fluid saturation of formations during production;
(d) assembling in the memory the determined measures of fluid saturation of formations for the reservoir; and
(e) forming an output display of selected ones of the determined measures of fluid saturation in formations of interest in the reservoir for evaluation of formation fluid saturation changes during production from the reservoir.

20. The data storage device of claim 19, wherein the instructions for processing initial data include instructions causing the data processing system to form measures of initial fluid contact levels in formations of the reservoir.

21. The data storage device of claim 19, wherein the instructions for processing production data include instructions causing the data processing system to form, measures of oil-water fluid contact levels in formations of the reservoir during production.

22. The data storage device of claim 19, wherein the instructions for processing production data include instructions causing the data processing system to form measures of oil-water fluid contact surfaces in formations of the reservoir during production.

23. The data storage device of claim 19, wherein the instructions for processing production data, include instructions causing the data processing system to form a petrophysical model of fluid saturation at the specified time for areas adjacent the wells from which production data are received.

24. The data storage device of claim 19, wherein the instructions for processing production data include instructions causing the processor to form output displays of changes between selected ones of the determined measures of fluid saturation.
